(19) United States
(12) Patent Application Publication
(10) Pub. No.: US 2004/0103193 A1
(43) Pub. Date: May 27, 2004

(54) Response time and resource consumption management in a distributed network environment

(76) Inventors: Suketu J. Pandya, Lake Oswego, OR (US); Anthony Hadfield, Vancouver, WA (US)

Correspondence Address: KOLISCH HARTWELL, P.C., 520 S.W. YAMHILL STREET, SUITE 200, PORTLAND, OR, 97204, US

(21) Appl. No.: 10/704,494

(22) Filed: Nov. 7, 2003

Related U.S. Application Data
(60) Provisional application No. 60/425,164, filed on Nov. 8, 2002.

(51) Int. Cl. G06F 15/173

(52) U.S. Cl. 709/224

(57) ABSTRACT

Software, systems and methods for managing a distributed network. For a given distributed device, the software includes a transaction monitor configured to identify transaction start times and stop times, and a resource consumption monitor configured to determine how much bandwidth is consumed by the distributed device during performance of a network transaction initiated by the device.

CROSS-REFERENCE TO RELATED APPLICATIONS

The application is also based upon and claims the benefit under 35 U.S.C. § 119 of U.S. provisional patent application Serial No. 60/425,164, filed Nov. 8, 2002, which is hereby incorporated by reference.

### BACKGROUND

Computer and telecommunication networks have shifted toward a predominantly distributed model, and have grown steadily in size, power and complexity. This growth has been accompanied by a corresponding increase in demands placed on information technology to increase enterprise-level productivity, operations and customer/user support. To achieve interoperability in increasingly complex network systems, TCP/IP and other standardized communication protocols have been aggressively deployed. Although many of these protocols have been effective at achieving interoperability, their widespread deployment has not been accompanied by a correspondingly aggressive development of management solutions for networks using these protocols.

Indeed, conventional computer networks provide little in the way of solutions for managing network resources, and instead typically provide what is known as “best efforts” service to all network traffic. Best efforts service is the default behavior of TCP/IP networks, in which network nodes simply drop packets indiscriminately when faced with excessive network congestion. With best efforts service, no mechanism is provided to avoid the congestion that leads to dropped packets, and network traffic is not categorized to ensure reliable delivery of more important data. Also, users are not provided with information about network conditions or underperforming resources. This lack of management frequently results in repeated, unsuccessful network requests, user frustration and diminished productivity.

Problems associated with managing network resources are intensified by the dramatic increase in the demand for these resources. New applications for use in distributed networking environments are being developed at a rapid pace. These applications have widely varying performance requirements. Multimedia applications, for example, have a very high sensitivity to jitter, loss and delay. By contrast, other types of applications can tolerate significant lapses in network performance. Many applications, particularly continuous media applications, have very high bandwidth requirements, while others have bandwidth requirements that are comparatively modest. A further problem is that many bandwidth-intensive applications are used for recreation or other low priority tasks.

In the absence of effective management tools, the result of this increased and varied competition for network resources is congestion, application unpredictability, user frustration and loss of productivity. When networks are unable to distinguish unimportant tasks or requests from those that are mission critical, network resources are often used in ways that are inconsistent with business objectives. Bandwidth may be wasted or consumed by low priority tasks. Customers may experience unsatisfactory network performance as a result of internal users placing a high load on the network.

Various solutions have been employed, with limited success, to address these network management problems. For example, to alleviate congestion, network managers often add more bandwidth to congested links. This solution is expensive and can be temporary—network usage tends to shift and grow such that the provisioned link soon becomes congested again. This often happens where the underlying cause of the congestion is not addressed. Usually, it is desirable to intelligently manage existing resources, as opposed to “over-provisioning,” i.e. simply providing more resources to reduce scarcity.

A broad, conceptual class of management solutions may be thought of as attempts to increase “awareness” in a distributed networking environment. The concept is that where the network is more aware of applications or other tasks running on networked devices, and vice versa, then steps can be taken to make more efficient use of network resources. For example, if network management software becomes aware that a particular user is running a low priority application, then the software could block or limit that user's access to network resources. If management software becomes aware that the network population at a given instance includes a high percentage of outside customers, bandwidth preferences and priorities could be modified to ensure that the customers had a positive experience with the network. In the abstract, increasing application and network awareness is a desirable goal, however application vendors largely ignore these considerations and tend to focus not on network infrastructure, but rather on enhancing application functionality.

Some management solutions have been proposed which contemplate interactions with the layered protocol stack used by a distributed device in network communications. A widely-implemented example of such a layered stack is the OSI reference model, depicted in FIG. 1. The layers of the OSI model are: application (layer 7), presentation (layer 6), session (layer 5), transport (layer 4), network (layer 3), data link (layer 2) and physical (layer 1). Another model forms the basis for the TCP/IP protocol suite. Its layers are application, transport, network, data link and hardware, as also depicted in FIG. 1. The TCP/IP layers correspond in function to the OSI layers, but without a presentation or session layer. In both models, data is processed and changes form as it is sequentially passed between the layers.

Prior management solutions have been proposed in which data flows are monitored at the transport layer and below. For example, a common multi-parameter classifier is the well known “five-tuple” consisting of (IP source address, IP destination address, IP protocol, TCP/UDP source port and TCP/UDP destination port). These parameters are all obtained at the transport and network layers of the models. Because these methods do not operate at any point higher than the transport layer, they cannot leverage the data available at the higher layers. The conventional systems are thus limited in their ability to make the network more application-aware and vice versa.

In addition, the known systems for managing network resources do not effectively address the problem of bandwidth management. Bandwidth is often consumed by low priority tasks at the expense of business critical applications. In systems that do provide for priority based bandwidth allocations, the bandwidth allocations are static and are not adjusted dynamically in response to changing network conditions.

Furthermore, existing technologies typically do not provide effective monitoring or measurement of transaction response times. User perceptions of network performance are heavily influenced by response times, yet existing technologies typically do not measure actual response times experienced by network users. Instead, as in the examples discussed, above, management software typically is deployed at low layers within the protocol stack. At these lower layers, it is often impossible to determine which network tasks and processes are associated with a particular network transaction. In other prior systems, response times are estimated using synthetic or simulated transactions. In either case, the prior systems commonly do not provide accurate measurements of the response time for actual user transactions. In addition, existing systems typically are not able to correlate transaction response times with the amount of network resources (e.g., bandwidth) consumed to perform the transaction.

One response time solution that suffers from several of these problems involves measuring the time required to receive Layer 4 packet acknowledgments from an individual target. Specifically, some products estimate response times by measuring the time elapsed between initiating a client transaction and receiving a packet acknowledgment from one of the targets involved in the transaction. One problem with this is that the actual response time is not measured, since the packet acknowledgment typically arrives well before the actual requested data is supplied from the target. The timing of the acknowledgment is used to infer the overall response time. Also, client transactions routinely involve multiple targets, such that the acknowledgement speed of one individual target says virtually nothing about the response time for the overall transaction. At best, the timing of packet acknowledgments can be used to obtain a rough estimate of response times experienced by the user.

### BRIEF DESCRIPTION OF THE DRAWINGS

FIG. 1 is a conceptual depiction of the OSI and TCP/IP layered protocol models.

FIG. 2 is a view of a distributed network system in which the software, systems and methods described herein may be deployed.

FIG. 3 is a schematic view of a computing device that may be deployed in the distributed network system of FIG. 2.

FIG. 4 is a block diagram view depicting exemplary agent modules and control modules that may be used to manage resources in a distributed network such as that depicted in FIG. 2.

FIG. 5 is a block diagram view depicting various exemplary components that may employed in connection with the described software, systems and methods.

FIG. 6 is a block diagram depicting an exemplary deployment of an agent module in relation to a layered protocol stack of a computing device.

FIG. 7 is a block diagram depicting another exemplary deployment of an agent module in relation to a layered protocol stack of a computing device.

FIG. 8 is a block diagram depicting yet another exemplary deployment of an agent module in relation to a layered protocol stack of a computing device.

FIG. 9 is a flowchart depicting a method for allocating bandwidth among a plurality of computers.

FIG. 10 is a flowchart depicting another method for allocating bandwidth among a plurality of computers.

FIG. 11 is a flowchart depicting yet another method for allocating bandwidth among a plurality of computers.

FIG. 12 is a flowchart depicting yet another method for allocating bandwidth among a plurality of computers.

FIG. 13 schematically depicts an exemplary agent module and associated distributed computing device according to the present description, including components configured to measure transaction response times and bandwidth consumption.

FIG. 14 is a flowchart depicting an exemplary method of monitoring network response times and correlating response times with transaction bandwidth consumption.

### DETAILED DESCRIPTION

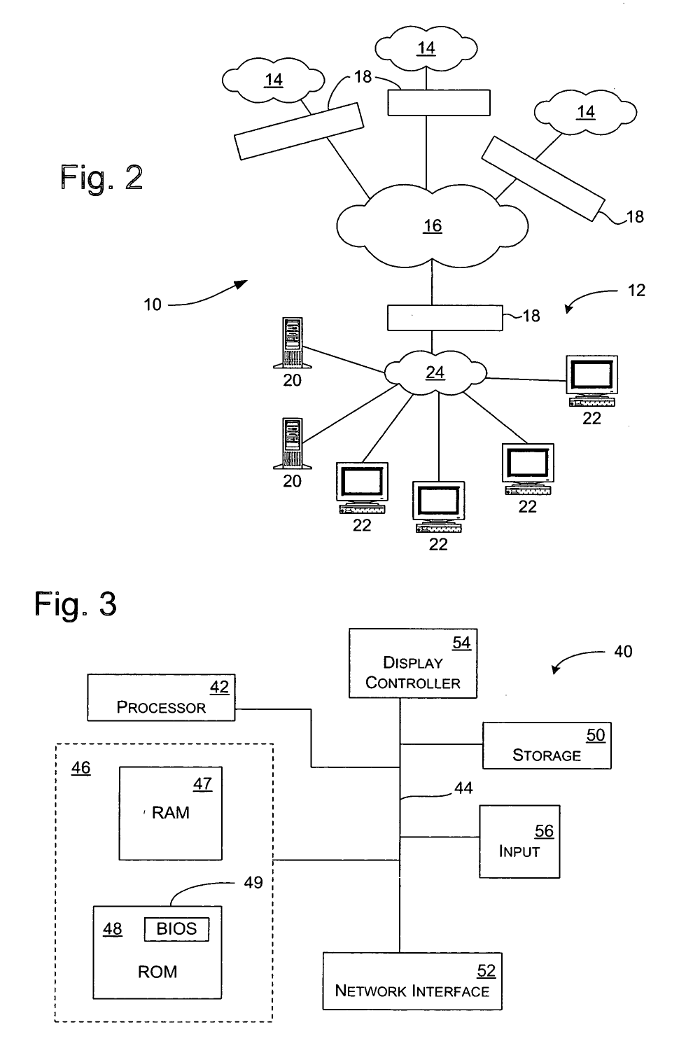

The present description provides a system and method for managing network resources in a distributed networking environment, such as distributed network 10 depicted in FIG. 2. The software, system and methods increase productivity and customer/user satisfaction, minimize frustration associated with using the network, and ultimately ensure that network resources are used in a way consistent with underlying business or other objectives.

The systems and methods may employ two main software components, an agent and a control module, also referred to as a control point. The agents and control points may be deployed throughout distributed network 10, and may interact with each other to manage network resources. A plurality of agents may be deployed to intelligently couple clients, servers and other computing devices to the underlying network. The deployed agents monitor, analyze and act upon network events relating to the networked devices with which they are associated. The agents typically are centrally coordinated and/or controlled by one or more control points. The agents and control points may interact to control and monitor network events, track operational and congestion status of network resources, select optimum targets for network requests, dynamically manage bandwidth usage, and share information about network conditions with customers, users and IT personnel.

As indicated, distributed network 10 may include a local network 12 and a plurality of remote networks 14 linked by a public network 16 such as the Internet. The local network and remote networks may be connected to the public network with network infrastructure devices such as routers 18.

Local network 12 typically includes servers 20 and client devices such as client computers 22 interconnected by network link 24. Additionally, local network 12 may include any number and variety of devices, including file servers, applications servers, mail servers, WWW servers, databases, client computers, remote access devices, storage devices, printers and network infrastructure devices such as routers, bridges, gateways, switches, hubs and repeaters. Remote networks 14 may similarly include any number and variety of networked devices.

Indeed, virtually any type of computing device may be connected to the networks depicted in FIG. 2, including general purpose computers, laptop computers, handheld computers, wireless computing devices, mobile telephones, pagers, pervasive computing devices and various other specialty devices. Typically, many of the connected devices are general purpose computers which have at least some of the elements shown in FIG. 3, a block diagram depiction of a computer system 40. Computer system 40 includes a processor 42 that processes digital data. The processor may be a complex instruction set computing (CISC) microprocessor, a reduced instruction set computing (RISC) microprocessor, a very long instruction word (VLIW) microprocessor, a processor implementing a combination of instruction sets, a microcontroller, or virtually any other processor/controller device. The processor may be a single device or a plurality of devices.

Referring still to FIG. 3, it will be noted that processor 42 is coupled to a bus 44 which transmits signals between the processor and other components in the computer system. Those skilled in the art will appreciate that the bus may be a single bus or a plurality of buses. A memory 46 is coupled to bus 44 and comprises a random access memory (RAM) device 47 (referred to as main memory) that stores information or other intermediate data during execution by processor 42. Memory 46 also includes a read only memory (ROM) and/or other static storage device 48 coupled to the bus that stores information and instructions for processor 42. A basic input/output system (BIOS) 49, containing the basic routines that help to transfer information between elements of the computer system, such as during start-up, is stored in ROM 48. A data storage device 50 also is coupled to bus 44 and stores information and instructions. The data storage device may be a hard disk drive, a floppy disk drive, a CD-ROM device, a flash memory device or any other mass storage device. In the depicted computer system, a network interface 52 also is coupled to bus 44. The network interface operates to connect the computer system to a network (not shown).

Computer system 40 may also include a display device controller 54 coupled to bus 44. The display device controller allows coupling of a display device to the computer system and operates to interface the display device to the computer system. The display device controller 54 may be, for example, a monochrome display adapter (MDA) card, a color graphics adapter (CGA) card, or other display device controller. The display device (not shown) may be a television set, a computer monitor, a flat panel display or other display device. The display device receives information and data from processor 42 through display device controller 54 and displays the information and data to the user of computer system 40.

An input device 56, including alphanumeric and other keys, typically is coupled to bus 44 for communicating information and command selections to processor 42. Alternatively, input device 56 is not directly coupled to bus 44, but interfaces with the computer system via infra-red coded signals transmitted from the input device to an infra-red receiver in the computer system (not shown). The input device may also be a remote control unit having keys that select characters or command selections on the display device.

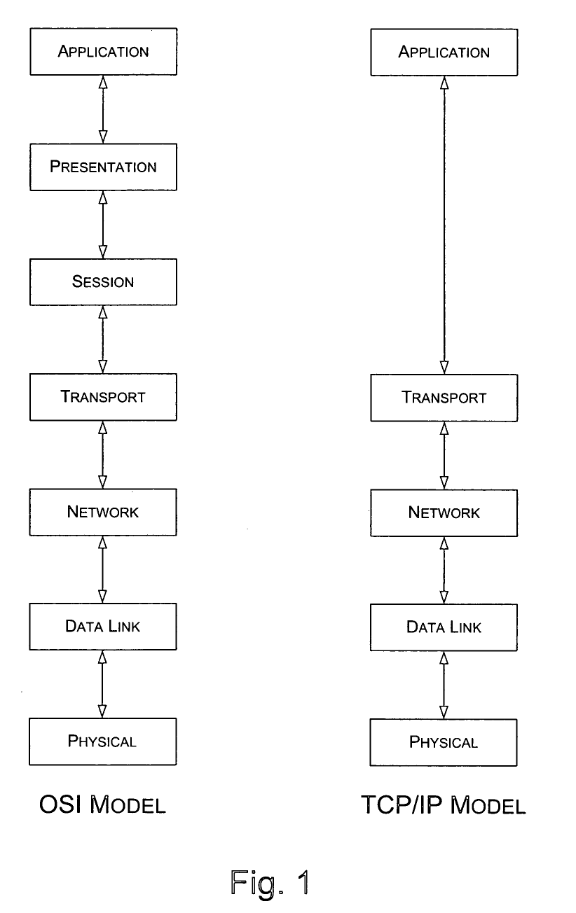

The various computing devices coupled to the networks of FIG. 2 typically communicate with each other across network links using communications software employing various communications protocols. The communications software for each networked device typically consists of a number of protocol layers, through which data is sequentially transferred as it is exchanged between devices across a network link. FIG. 1 respectively depicts the OSI layered protocol model and a layered model based on the TCP/IP suite of protocols. These two models dominate the field of network communications software. As seen in the figure, the OSI model has seven layers, including an application layer, a presentation layer, a session layer, a transport layer, a network layer, a data link layer and a physical layer. The TCP/IP-based model includes an application layer, a transport layer, a network layer, a data link layer and a physical layer.

Each layer in the models plays a different role in network communications. Conceptually, all of the protocol layers define and lie within a data transmission path that is “between” an application program running on the particular networked device and the network link, with the application layer being closest to the application program. When data is transferred from an application program running on one computer across the network to an application program running on another computer, the data is transferred down through the protocol layers of the first computer, across the network link, and then up through the protocol layers on the second computer.

In both of the depicted models, the application layer is responsible for interacting with an operating system of the networked device and for providing a window for application programs running on the device to access the network. The transport layer is responsible for providing reliable, end-to-end data transmission between two end points on a network, such as between a client device and a server computer, or between a web server and a DNS server. Depending on the particular transport protocol, transport functionality may be realized using either connection-oriented or connectionless data transfer. The network layer typically is not concerned with end-to-end delivery, but rather with forwarding and routing data to and from nodes between endpoints. The layers below the transport and network layers perform other functions, with the lowest levels addressing the physical and electrical issues of transmitting raw bits across a network link.

The systems and methods described herein are applicable to a wide variety of network environments employing communications protocols adhering to either of the layered models depicted in FIG. 1, or to any other layered model. Furthermore, the systems and methods are applicable to any type of network topology, and to networks using both physical and wireless connections.

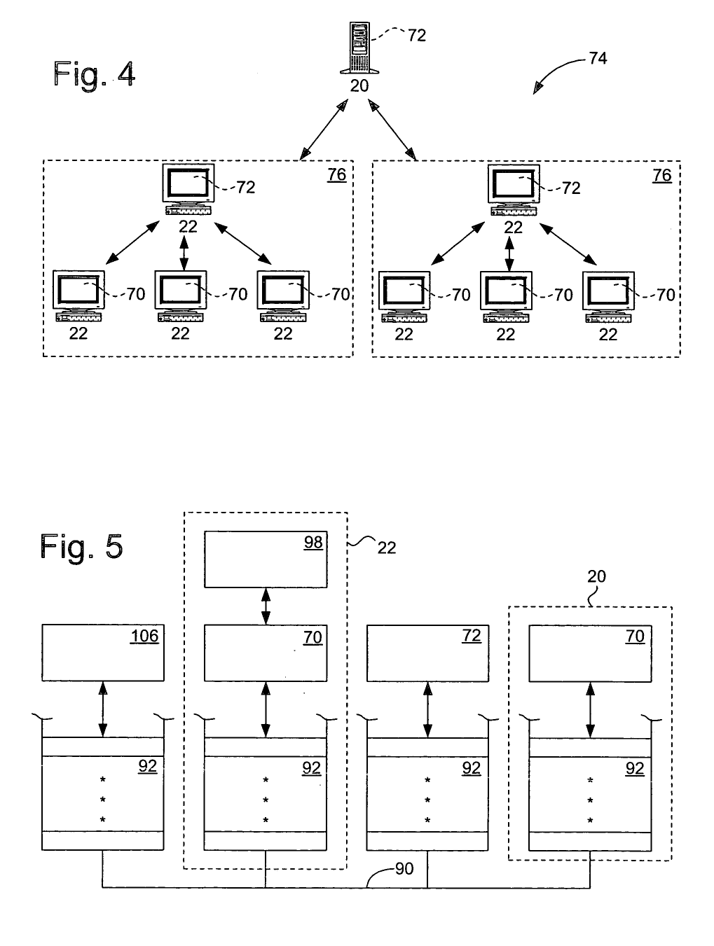

The present description provides software, systems and methods for managing the resources of an enterprise network, such as that depicted in FIG. 2. This may be accomplished using two interacting software components, an agent and a control point, both of which may be adapted to run on, or be associated with, computing devices such as the computing device described with reference to FIG. 3. As seen in FIG. 4, a plurality of agents 70 and one or more control points 72 may be deployed throughout distributed network 74 by loading the agent and control point software modules on networked computing devices such as clients 22 and server 20. As will be discussed in detail, the agents and control points may be adapted and configured to enforce system policies; to monitor and analyze network events, and take appropriate action based on these events; to provide valuable information to users of the network; and ultimately to ensure that network resources are efficiently used in a manner consistent with underlying business or other goals.

The described software, systems and methods may be configured with a configuration utility or other like software component. Typically, this component is a platform-independent application that provides a graphical user interface for centrally managing configuration information for the control points and agents. In addition, the configuration utility may be adapted to communicate and interface with other management systems, including management platforms supplied by other vendors.

As indicated in FIG. 4, each control point 72 typically is associated with multiple agents 70, and the associated agents are referred to as being within a domain 76 of the particular control point. The control points coordinate and control the activity of the distributed agents within their domains. In addition, the control points may monitor the status of network resources, and share this information with management and support systems and with the agents.

Control points 72 and agents 70 may be flexibly deployed in a variety of configurations. For example, each agent may be associated with a primary control point and one or more backup control points that will assume primary control if necessary. Such a configuration is illustrated in FIG. 4, where control points 72 within the dashed lines function as primary connections, with the control point associated with server device 20 functioning as a backup connection for all of the depicted agents. In addition, the described exemplary systems may be configured so that one control point coordinates and controls the activity of a single domain, or of multiple domains. Alternatively, one domain may be controlled and coordinated by the cooperative activity of multiple control points. In addition, agents may be configured to have embedded control point functionality, and may therefore operate without an associated control point entity.

Typically, the agents monitor network resources and the activity of the device with which they are associated, and communicate this information to the control points. In response to monitored network conditions and data reported by agents, the control points may alter the behavior of particular agents in order to provide the desired network services. The control points and agents may be loaded on a wide variety of devices, including general purpose computers, servers, routers, hubs, palm computers, pagers, cellular telephones, and virtually any other networked device having a processor and memory. Agents and control points may reside on separate devices, or simultaneously on the same device.

FIG. 5 illustrates an example of the way in which the various components of the described software, systems and methods may be physically interconnected with a network link 90. The components are all connected to network link 90 by means of layered communications protocol software 92. The components communicate with each other via the communications software and network link. As will be appreciated by those skilled in the art, network link 90 may be a physical or wireless connection, or a series of links including physical and wireless segments. More specifically, the depicted system includes an agent 70 associated with a client computing device 22, including an application program 98. Another agent is associated with server computing device 20. The agents monitor the activity of their associated computing devices and communicate with control point 72. Configuration utility 106 communicates with all of the other components, and with other management systems, to configure the operation of the various components and monitor the status of the network.

The system policies that define how network resources are to be used may be centrally defined and tailored to most efficiently achieve underlying goals. Defined policies are accessed by the control points, which in turn communicate various elements and parameters associated with the policies to the agents within their domain. At a very basic level, a policy contains rules about how network resources are to be used, with the rules containing conditions and actions to be taken when the conditions are satisfied. The agents and control points monitor the network and devices connected to the network to determine when various rules apply and whether the conditions accompanying those rules are satisfied. Once the agents and/or control points determine that action is required, they take the necessary action(s) to enforce the system policies.

For example, successful businesses often strive to provide excellent customer services. This underlying business goal can be translated into many different policies defining how network resources are to be used. One example of such a policy would be to prevent or limit access to non-business critical applications when performance of business critical applications is degraded beyond a threshold point. Another example would be to use QoS techniques to provide a guaranteed or high level of service to e-commerce applications. Yet another example would be to dynamically increase the network bandwidth allocated to a networked computer whenever it is accessed by a customer. Also, bandwidth for various applications might be restricted during times when there is heavy use of network resources by customers.

Control points 72 would access these policies and provide policy data to agents 70. Agents 70 and control points 72 would communicate with each other and monitor the network to determine how many customers were accessing the network, what computers the customer(s) were accessing, and what applications were being accessed by the customers. Once the triggering conditions were detected, the agents and control points would interact to re-allocate bandwidth, provide specified service levels, block or restrict various non-customer activities, etc.

Another example of policy-based management would be to define an optimum specification of network resources or service levels for particular types of network tasks. The particular policies would direct the management entities to determine whether the particular task was permitted, and if permitted, the management entities would interact to ensure that the desired level of resources was provided to accomplish the task. If the optimum resources were not available, the applicable policies could further specify that the requested task be blocked, and that the requesting user be provided with an informative message detailing the reason why the request was denied. Alternatively, the policies could specify that the user be provided with various options, such as proceeding with the requested task, but with sub-optimal resources, or waiting to perform the task until a later time.

For example, continuous media applications such as IP telephony have certain bandwidth requirements for optimum performance, and are particularly sensitive to network jitter and delay. Policies could be written to specify a desired level of service, including bandwidth requirements and threshold levels for jitter and delay, for client computers attempting to run IP telephony applications. The policies would further direct the agents and control modules to attempt to provide the specified level of service. Security checking could also be included to ensure that the particular user or client computer was permitted to run the application. In the event that the specified service level could not be provided, the requesting user could be provided with a message indicating that the resources for the request were not available. The user could also be offered various options, including proceeding with a sub-optimal level of service, placing a conventional telephone call, waiting to perform the task until a later time, etc.

The software, systems and methods of the present description may be used to implement a wide variety of system policies. The policy rules and conditions may be based on any number of parameters, including IP source address, IP destination address, source port, destination port, protocol, application identity, user identity, device identity, URL, available device bandwidth, application profile, server profile, gateway identity, router identity, time-of-day, network congestion, network load, network population, available domain bandwidth and resource status, to name but a partial list. The actions taken when the policy conditions are satisfied can include blocking network access, adjusting service levels and/or bandwidth allocations for networked devices, blocking requests to particular URLs, diverting network requests away from overloaded or underperforming resources, redirecting network requests to alternate resources and gathering network statistics.

Some of the parameters listed above may be thought of as “client parameters,” because they are normally evaluated by an agent monitoring a single networked client device. These include IP source address, IP destination address, source port, destination port, protocol, application identity, user identity, available device bandwidth and URL. Other parameters, such as application profile, server profile, gateway identity, router identity, time-of-day, network congestion, network load, network population, available domain bandwidth and resource status may be though of as “system parameters” because they pertain to shared resources, aggregate network conditions or require evaluation of data from multiple agent modules. Despite this, there is not a precise distinction between client parameters and system parameters. Certain parameters, such as time-of-day, may be considered either a client parameter or a system parameter, or both.

Policy-based network management, QoS implementation, and the other functions of the agents and control points depend on obtaining real-time information about the network. As will be discussed, certain described embodiments and implementations provide improvements over known policy-based QoS management solutions because of the enhanced ability to obtain detailed information about network conditions and the activity of networked devices. Many of the policy parameters and conditions discussed above are accessible due to the particular way the agent module embodiments may be coupled to the communications software of their associated devices. Also, as the above examples suggest, managing bandwidth and ensuring its availability for core applications is an increasingly important consideration in managing networks. Certain embodiments described herein provide for improved dynamic allocation of bandwidth and control of resource consumption in response to changing network conditions.

The ability of the systems described herein to flexibly deploy policy-based, QoS management solutions based on detailed information about network conditions has a number of significant benefits. These benefits include reducing frustration associated with using the network, reducing help calls to IT personnel, increasing productivity, lowering business costs associated with managing and maintaining enterprise networks, and increased customer/user loyalty and satisfaction. Ultimately, the systems and methods ensure that network resources are used in a way that is consistent with underlying goals and objectives.

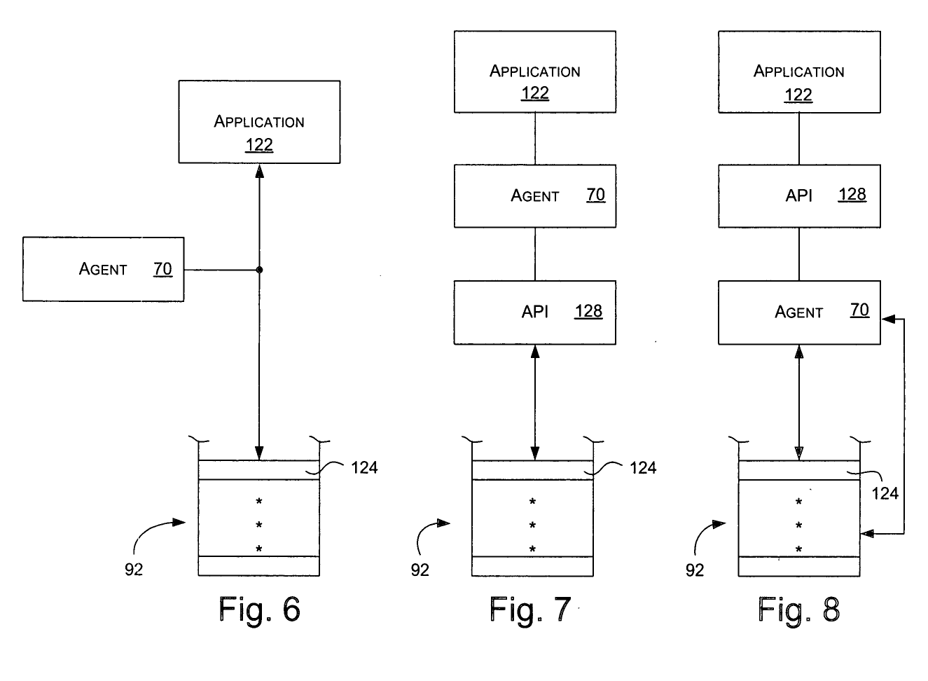

Referring now to FIGS. 6-8, illustrative embodiments of the agent module will be more particularly described. The agent modules may monitor the status and activities of its associated client, server, pervasive computing device or other computing device; communicate this information to one or more control points; enforce system policies under the direction of the control points; and provide messages to network users and administrators concerning network conditions. FIGS. 6-8 are conceptual depictions of networked computing devices, and show how the agent software may be associated with the networked devices relative to layered protocol software used by the devices for network communication.

As seen in FIG. 6, agent 70 is interposed between application program 122 and a communications protocol layer for providing end-to-end data transmission, such as transport layer 124 of communications protocol stack 92. Typically, the agent modules described herein may be used with network devices that employ layered communications software adhering to either the OSI or TCP/IP-based protocol models. Thus, agent 70 is depicted as “interposed,” i.e. in a data path, between an application program and a transport protocol layer. However, it will be appreciated by those skilled in the art that the various agent module embodiments may be used with protocol software not adhering to either the OSI or TCP/IP models, but that nonetheless includes a protocol layer providing transport functionality, i.e. providing for end-to-end data transmission.

Because of the depicted position within the data path, agent 70 is able to monitor network traffic and obtain information that is not available by hooking into transport layer 124 or the layers below the transport layer. At the higher layers, the available data is richer and more detailed. Hooking into the stack at higher layers allows the network to become more “application-aware” than is possible when monitoring occurs at the transport and lower layers.

The agent modules may be interposed at a variety of points between application program 122 and transport layer 124. Specifically, as shown in FIGS. 7 and 8, agent 70 may be associated with a client computer so that it is adjacent an application programming interface (API) adapted to provide a standardized interface for application program 122 to access a local operating system (not shown) and communications stack 92. In FIG. 7, agent 70 is adjacent a winsock API 128 and interposed between application program 122 and the winsock interface. FIG. 8 shows an alternate configuration, in which agent 70 again hooks into a socket object, such as API 128, but downstream of the socket interface (i.e., between the socket interface and the network). With either configuration, the agent is interposed between the application layer and transport layer 124 of communications stack 92, and is adapted to directly monitor data received by or sent from the winsock interface.

As shown in FIG. 8, agent 70 may be configured to hook into lower layers of communications stack 92. This allows the agent to accurately monitor network traffic volumes by providing a correction mechanism to account for data compression or encryption occurring at protocol layers below transport layer 124. For example, if compression or encryption occurs within transport layer 124, monitoring at a point above the transport layer would yield an inaccurate measure of the network traffic associated with the computing device. Hooking into lower layers with agent 70 allows network traffic to be accurately measured in the event that compression, encryption or other data processing that qualitatively or quantitatively affects network traffic occurs at lower protocol layers.

The agent modules of the present description may include various components for performing various functions. For example, the agent module may include a redirector module adapted to intercept winsock API calls made by applications running on networked devices, such as the client computers depicted in FIGS. 2 and 3. After interception, the redirector module may hand the calls to one or more other agent components for processing. As discussed with reference to FIGS. 6-8, the redirection mechanism typically is positioned so as to allow the agent to conduct monitoring at a data transmission point between an application program running on the device and the transport layer of the communications stack. Depending on the configuration of the agent and control point, the intercepted winsock calls may be rejected, changed, or transparently passed on through the network stack by agent 70.

The agent typically also includes one or more components adapted to control network traffic associated with the distributed computing device on which the agent is running. This component(s) may be configured to implement QoS and system policies and assist in monitoring network conditions. QoS techniques may be implemented, for example, by controlling the network traffic flow between applications running on the agent device and the network link. The traffic flow may be controlled to deliver a specified network service level, which may include specifications of bandwidth, data throughput, jitter, delay and data loss.

To provide the specified network service level, the traffic control components of the agent module may maintain a queue or plurality of queues. When data is sent from the distributed device (e.g., a client computer) out to the network, or from the network to the distributed device, that data may be intercepted by the agent module, as discussed above, and placed into an appropriate queue. The control points may be configured to periodically provide traffic control commands, which may include the QoS parameters and service specifications discussed above. In response, the agent module controls the passing of data into, through or out of the queues in order to provide the specified service level.

More specifically, the outgoing traffic rate may be controlled using a plurality of priority-based transmission queues. When an application or process is invoked by a computing device with which agent 70 is associated, a priority level is assigned to the application, based on centrally defined policies and priority data supplied by the control point. Specifically, as will be discussed, the control points maintain user profiles, applications profiles and network resource profiles. These profiles include priority data which is provided to the agents.

The transmission queues may be configured to release data for transmission to the network at regular intervals. Using parameters specified in traffic control commands issued by a control point, the traffic control mechanism of the agent module calculates how much data can be released from the transmission queues in a particular interval. For example, if the specified average traffic rate is 100 Kbps and the queue release interval is 1 ms, then the total amount of data that the queues can release in a given interval is 100 bits. The relative priorities of the queues containing data to be transmitted determine how much of the allotment may be released by each individual queue. For example, assuming there are only two queues, Q1 and Q2, that have data queued for transmission, Q1 will be permitted to transmit 66.66% of the overall allotted interval release if its priority is twice that of Q2. Q2 would only be permitted to release 33.33% of the allotment. If their priorities were equal, each queue would be permitted to release 50% of the interval allotment for forwarding to the network link.

If waiting data is packaged into units that are larger than the amount a given queue is permitted to release, the queue may be configured to accumulate “credits” for intervals in which it does not release any waiting data. When enough credits are accumulated, the waiting message is released for forwarding to the network.

Similarly, to control the rate at which network traffic is received, a plurality of receive queues may be provided within the agent module. In addition to the methods discussed above, various other methods may be employed to control the rate at which network traffic is sent and received by the queues. Also, the behavior of the queues may be controlled through various methods to control jitter, delay, loss and response time for network connections.

The queues may also be configured to detect network conditions such as congestion and slow responding applications or servers. For example, for each application, transmitted packets or other data units may be time stamped when passed out of a transmit queue. When corresponding packets are received for a particular application, the receive and send times may be compared to detect network congestion and/or slow response times for various target resources. This information may be reported to the control points and shared with other agents within the domain. The response time and other performance information obtained by comparing transmit and receive times may also be used to compile and maintain statistics regarding various network resources.

Using this detection and reporting mechanism, a control point may be configured to reduce network loads by instructing the traffic control mechanism of each agent module to close low priority sessions and block additional sessions whenever heavy network congestion is reported by one of the agents. Messages may also be provided to each user explaining why sessions are being closed. In addition to closing the existing sessions, the control point may be configured to instruct the agents to block any further sessions. This action may also be accompanied by a user message that is provided in response to attempts to launch a new application or network process. When the network load is reduced, the control point will send a message to the agents allowing sessions.

The agent module may also be configured to aid in identifying downed or under-performing network resources. When a connection to a target resource fails, the agent module may initiate launching of an executable to perform a root-cause analysis of the problem. Agent 70 may then provide the relevant control point with a message identifying the resource and its status, if possible.

In addition, when a connection fails, a message may be provided to the user, and the user may be provided with the option to initiate an autoconnect routine targeting the unavailable resource. Enabling autoconnect causes the agent to periodically retry the unavailable resource. This feature may be disabled, if desired, to allow the control point to assume responsibility for determining when the resource becomes available again. As will be later discussed, the described system may be configured so that the control modules assume responsibility for monitoring unavailable resources in order to minimize unnecessary network traffic.

As discussed below, the agents may also be configured to monitor network conditions and resource usage for the purpose of compiling statistics. An additional function of the previously described traffic control mechanism is to aid in performing these functions by providing information to other agent components regarding accessed resources, including resource performance and frequency of access.

The agent modules of the present disclosure may also include a popapp or like component adapted to launch various application modules to perform various operations and enhance the functioning of the described system. These application modules are often relatively small, and may be referred to as popapps. Popapps may be designed to: detect and diagnose network conditions such as downed resources; provide specific messages to users and IT personnel regarding errors and network conditions; and interface with other information management, reporting or operational support systems, such as policy managers, service level managers, and network and system management platforms. Popapps may be customized to add features to existing products, to tailor products for specific customer needs, and to integrate the software, systems and methods with technology supplied by other vendors.

In typical implementations, the agent module will also include an administrator component adapted to: interact with various other agent modules; maintain and provide network statistics; and provide a management interface by which the agent may be centrally configured. A central configuration utility may, for example, be implemented to run on a control point responsible for controlling a number of agent devices. The utility would access the agent module via the management interface provided by the administrator component of the agent module. The administrator component may also serve as a repository for local reporting and statistics information to be communicated upstream to one or more control points operating within the agent's domain. Based on information obtained by other agent modules, the administrator component may locally maintain information regarding accessed servers, DNS servers, gateways, routers, switches, applications and other resources. This information is communicated upstream on request to the control point, and may be used for network planning or to dynamically alter the behavior of agents. In addition, the administrator component may store system policies and provide policy data to various agent components as needed to implement and enforce the policies. The administrator component may also be adapted to support interfacing the described software and systems with standardized network management protocols and platforms.

The agent module may further be configured to provide address resolving services. A local cache of DNS information may be provided, for example, in order to locally and efficiently resolve address requests. If the request cannot be resolved locally, the request may be submitted upstream to a control point, which resolves the address with its own cache, provided the address is in the control point cache and the user has permission to access the address. If the request cannot be resolved with the control point cache, the connected control point submits the request to a DNS server for resolution. If the address is still not resolved at this point, the control point sends a message to the agent, and the agent then submits the request directly to its own DNS server for resolution.

The address-resolving mechanism of the agent module may also be adapted to share the content of local address requests with upstream control points. This may provide system administrators with valuable information about network usage, and may be used to create dynamically updated lists of popular network targets. Such dynamically updated lists may be employed to redirect address resolving requests and other network requests to alternate targets, if necessary.

In addition to the above components and functions, the agent will often be provided with various messaging features enabling communication between components of the agent (internal communications), and between the agent and the one or more control points with which the agent interacts (external communications). Unicast or multicast addressing schemes may be employed for the communications, and encryption, encoding and/or other methods may be employed in connection with the internal and external messaging.

Referring now to the control points, the control point may also be provided with various components and/or features to provide various functions. In typical implementations, one function of the control point is to implement policy-based, QoS techniques by coordinating the service-level enforcement activities of the agents. As part of this function, a traffic control mechanism of the control point dynamically allocates bandwidth among the agents in its domain by regularly obtaining allocation data from the agents (including data pertaining to past and current consumption), calculating bandwidth allocations for each agent based on this data, and communicating the calculated allocations to the agents for enforcement. For example, control point 72 can be configured to recalculate bandwidth allocations at regular intervals, such as every five seconds. During each cycle, between re-allocation, the agents restrict bandwidth usage by their associated devices (e.g., distributed client computers) to the allocated amount and monitor the amount of bandwidth actually used. At the end of the cycle, each agent reports the bandwidth usage and other allocation data to the control point to be used in re-allocating bandwidth.

During re-allocation, the traffic control mechanism of the control point divides the total bandwidth available for the upcoming cycle among the agents within the domain according to the data reported by the agents. The result is a configured bandwidth CB particular to each individual agent, corresponding to that agent's fair share of the available bandwidth. The priorities and configured bandwidths are a function of system policies, and may be based on a wide variety of parameters, including application identity, user identity, device identity, source address, destination address, source port, destination port, protocol, URL, time of day, network load, network population, and virtually any other parameter concerning network resources that can be communicated to, or obtained by the control point. The detail and specificity of client-side parameters that may be supplied to the control point is greatly enhanced by the position of agent redirector module 130 relative to the layered communications protocol stack. The high position within the stack allows bandwidth allocation and, more generally, policy implementation, to be performed based on very specific triggering criteria. This may greatly enhance the flexibility and power of the described software, systems and methods.

The priority data reported by the agents may include priority data associated with multiple application programs running on a single networked device. In such a situation, the associated agent may be configured to report an “effective application priority,” which is a function of the individual application priorities. For example, if device A were running two application programs and device B were running a single application program, device A's effective application priority would be twice that of device B, assuming that the individual priorities of all three applications were the same. The reported priority data for a device running multiple application programs may be further refined by weighting the reported priority based on the relative degree of activity for each application program. Thus, in the previous example, if one of the applications running on device A was dormant or idle, the contribution of that application to the effective priority of device A would be discounted such that, in the end, device A and device B would have nearly the same effective priority. To determine effective application priority using this weighted method, the relative degree of activity for an application may be measured in terms of bandwidth usage, transmitted packets, or any other activity-indicating criteria.

In addition to priority data, each agent may be configured to report the amount of bandwidth UB used by its associated device during the prior period, as discussed above. Data is also available for each device's allocated bandwidth AB for the previous cycle. The control point may compare configured bandwidth CB, allocated bandwidth AB or utilized bandwidth UB for each device, or any combination of those three parameters to determine the allocations for the upcoming cycle. To summarize the three parameters, UB is the amount the networked device used in the prior cycle, AB is the maximum amount they were allowed to use, and CB specifies the device's “fair share” of available bandwidth for the upcoming cycle.

Both utilized bandwidth UB and allocated bandwidth AB may be greater than, equal to, or less than configured bandwidth CB. This may happen, for example, when there are a number of networked devices using less than their configured share CB. To efficiently utilize the available bandwidth, these unused amounts are allocated to devices requesting additional bandwidth, with the result being that some devices are allocated amount AB that exceeds their configured fair share CB. Though AB and UB may exceed CB, utilized bandwidth UB cannot normally exceed allocated bandwidth AB, because the agent traffic control module enforces the allocation.

Any number of processing algorithms may be used to compare CB, AB and UB for each agent in order to calculate a new allocation, however there are some general principles which are often employed. For example, when bandwidth is taken away from devices, it is often desirable to first reduce allocations for devices that will be least affected by the downward adjustment. Thus, the control point may be configured to first reduce allocations of clients or other devices where the associated agent reports bandwidth usage UB below the allocated amount AB. Presumably, these devices will not be affected if their allocation is reduced. Generally, allocations will not be reduced until all the unused allocations, or portions of allocations, have been reduced. The traffic module may be configured to then reduce allocations that are particularly high, or make adjustments according to some other criteria.

The traffic control mechanism of the control point may also be configured so that when bandwidth becomes available, the newly-available bandwidth is provisioned according to generalized preferences. For example, the traffic module can be configured to provide surplus bandwidth first to agents that have low allocations and that are requesting additional bandwidth. After these requests are satisfied, surplus bandwidth may be apportioned according to priorities or other criteria.

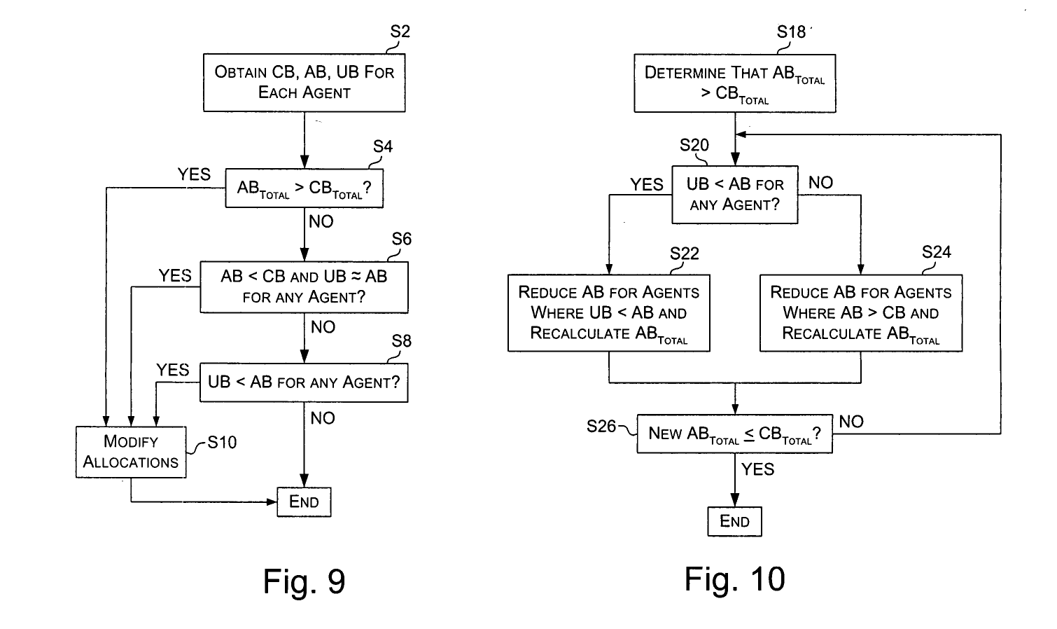

FIGS. 9, 10, 11 and 12 depict examples of various methods that may be implemented to dynamically allocate bandwidth. These methods may be implemented in connection with or independently of the specific exemplary embodiments of agents and control points described above. Referring first to FIG. 9, the figure depicts a process by which it is determined whether any adjustments to bandwidth allocations AB are necessary. Allocated bandwidths AB for certain agents are adjusted in at least the following circumstances. First, as seen in steps S4 and S10, certain allocated bandwidths AB are modified if the sum of all the allocated bandwidths ABtotal exceeds the sum of the configured bandwidths CBtotal. This situation may occur where, for some reason, a certain portion of the total bandwidth available to the agents in a previous cycle becomes unavailable, perhaps because it has been reserved for another purpose. In such a circumstance, it is important to reduce certain allocations AB to prevent the total allocations from exceeding the total bandwidth available during the upcoming cycle.

Second, if there are any agents for which AB<CB and UB≈AB, the allocation for those agents is modified, as seen in steps S6 and S10. The allocations for any such agent typically are increased. In this situation, an agent has an allocation AB that is less than their configured bandwidth CB, i.e. their existing allocation is less than their fair share of the bandwidth that will be available in the upcoming cycle. Also, the reported usage UB for the prior cycle is at or near the enforced allocation AB, and it can thus be assumed that more bandwidth would be consumed by the associated device if its allocation AB were increased.

Third, if there are any agents reporting bandwidth usage UB that is less than their allocation AB, as determined at step S8, then the allocation AB for such an agent is reduced for the upcoming period to free up the unused bandwidth. Steps S4, S6 and S8 may be performed in any suitable order. Collectively, these three steps ensure that certain bandwidth allocations are modified, i.e. increased or reduced, if one or more of the following three conditions are true: (1) ABtotal>CBtotal, (2) AB<CB and UB≈AB for any agent, or (3) UB<AB for any agent. If none of these are true, the allocations AB from the prior period typically are not adjusted. At step S10, allocations AB are modified as necessary. After all necessary modifications are made, the control point communicates the new allocations to the agents for enforcement during the upcoming cycle.

FIG. 10 depicts re-allocation of bandwidth to ensure that total allocations AB do not exceed the total bandwidth available for the upcoming cycle. At step S18, it has been determined that the sum of allocations AB from the prior period exceed the available bandwidth for the upcoming period, i.e. ABtotal>CBtotal. In this situation, certain allocations AB must be reduced. As seen in steps S20 and S22, the method may be implemented so that the first allocations that are reduced are those of agents that report bandwidth usage levels below their allocated amounts (e.g., UB<AB for a particular agent). These agents are not using a portion of their allocations, and thus are unaffected or only minimally affected when the unused portion of the allocation is removed. At step S20, the method includes determining whether there are any such agents. At step S22, the allocations AB for some or all of these agents are reduced. These reductions may be gradual, or the entire unused portion of the allocation may be removed at once.

After any and all unused allocation portions have been removed, it is possible that further reductions may be required to appropriately reduce the overall allocations ABtotal. As seen in step S24, further reductions are taken from agents with existing allocations AB that are greater than configured bandwidth CB, i.e. AB>CB. In contrast to step S22, where allocations were reduced due to unused bandwidth, bandwidth is removed at step S24 from devices with existing allocations that exceed the calculated “fair share” for the upcoming cycle. As seen at step S26, the reductions taken at steps S22 and S24 may be performed until the total allocations ABtotal are less than or equal to the total available bandwidth CBtotal for the upcoming cycle.

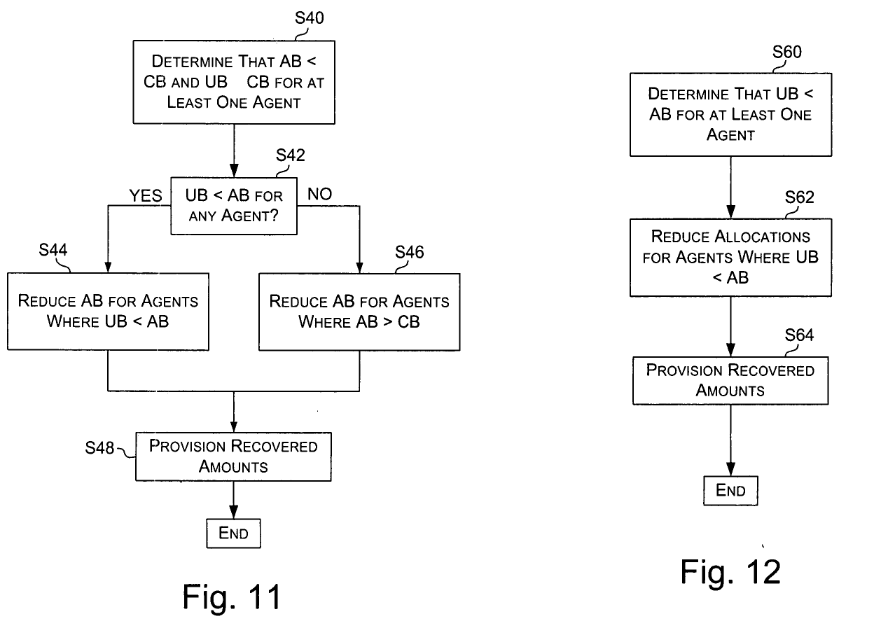

FIG. 11 depicts a method for increasing the allocation of certain agents. As discussed with reference to FIG. 9, where AB<CB and UB≈AB for any agent, the allocation AB for such an agent should be increased. The existence of this circumstance has been determined at step S40. To provide these agents with additional bandwidth, the allocations for certain other agents typically need to be reduced. Similar to steps S20 and S22 of FIG. 10, unutilized bandwidth is first identified and removed (steps S42 and S44). Again, the control point may be configured to vary the rate at which unused allocation portions are removed. If reported data does not reflect unutilized bandwidth, the method may include reducing allocations for agents having an allocation AB higher than their respective configured share CB, as seen in step S46. The bandwidth recovered in steps S44 and S46 may then be provided to agents requesting additional bandwidth. Any number of methods may be used to provision the recovered bandwidth. For example, preference may be given to agents reporting the largest discrepancy between their allocation AB and their configured share CB. Alternatively, preferences may be based on application identity, user identity, priority data, other client or system parameters, or any other suitable criteria.

FIG. 12 depicts a general method for reallocating unused bandwidth. At step S60, it has been determined that certain allocations AB are not being fully used by the respective agents, i.e. UB<AB for at least one agent. At step S62, the allocations AB for these agents are reduced. As with the reductions and modifications described with reference to FIGS. 9, 10 and 11, the rate of the adjustment may be varied through configuration changes to the control point. For example, it may be desired that only a fraction of unused bandwidth be removed during a single reallocation cycle. Alternatively, the entire unused portion may be removed and reallocated during the reallocation cycle.

In step S64 of FIG. 12, the recovered amounts are provisioned as necessary. The recovered bandwidth may be used to eliminate a discrepancy between the total allocations ABtotal and the available bandwidth, as in FIG. 10, or to increase allocations of agents who are requesting additional bandwidth and have relatively low allocations, as in FIG. 11. In addition, if there is enough bandwidth recovered, allocations may be increased for agents requesting additional bandwidth, i.e. UB≈AB, even where the current allocation AB for such an agent is fairly high, e.g. AB>CB. As with the methods depicted in FIGS. 10 and 11, the recovered bandwidth may be reallocated using a variety of methods and according to any suitable criteria.

The rate at which allocation adjustments are made may be varied as desired and appropriate to a given setting. For example, assume that a particular distributed device is allocated 64 KBps (AB) and reports usage during the prior cycle of 62 KBps (UB). In many cases, it may not be readily apparent how much additional bandwidth, if any, the device would use. If the allocation were dramatically increased, say doubled, it is possible that a significant portion of the increase would go unused. However, because the device is using an amount roughly equal to the enforced allocation AB, it may be assumed that the device would use more if the allocation were increased. Thus, it is often preferable to provide small, incremental increases. The amount of these incremental adjustments and the rate at which they are made may be configured with the previously described central configuration utility. If the device consumes the additional amounts, successive increases can be provided if additional bandwidth is available.

In addition, the bandwidth allocations and calculations may be performed separately for the transmit and receive rates for the networked devices. In other words, the methods described with reference to FIGS. 9, 10, 11 and 12 may be used to calculate a transmit allocation for a particular device, as well as a separate receive allocation. Alternatively, the calculations may be combined to yield an overall bandwidth allocation.

It should be appreciated from the above that the agent software may include a component that hooks into the network stack at a relatively high position within the stack. In particular, in typical implementations, the software interacts with a socket object, such as Winsock, that couples an application to the lower layers of a network communications stack. This agent component may be referred to as a Layer Service Provider, or LSP. As discussed above, one aspect of the LSP is concerned with network resource consumption by the associated computer. The LSP can be employed to passively monitor network data flows to and from the associated computer, and/or may be actively employed to control those data flows. For example, the LSP may be employed to encrypt or compress data, to dynamically control and/or monitor bandwidth consumption by the associated computer, and/or to block access to particular resources.

From the above, it will also be appreciated that the nature of the monitoring and control provided by the agent may be determined in part by the point within the communications stack at which the agent accesses network data flows. At each conceptual level in the network communications stack, the data is organized somewhat differently, and the form of the data often determines what type of monitoring and control may be performed.

To provide management functions relative to certain types of user transactions, the systems and methods of the present disclosure may further include use of an application-level component. Typically, this component is configured to reside “above” the LSP for purposes of its relationship to network-related activities of the distributed computing device. Specifically, the application-level component is positioned higher than the LSP relative to the layered network protocol stack.

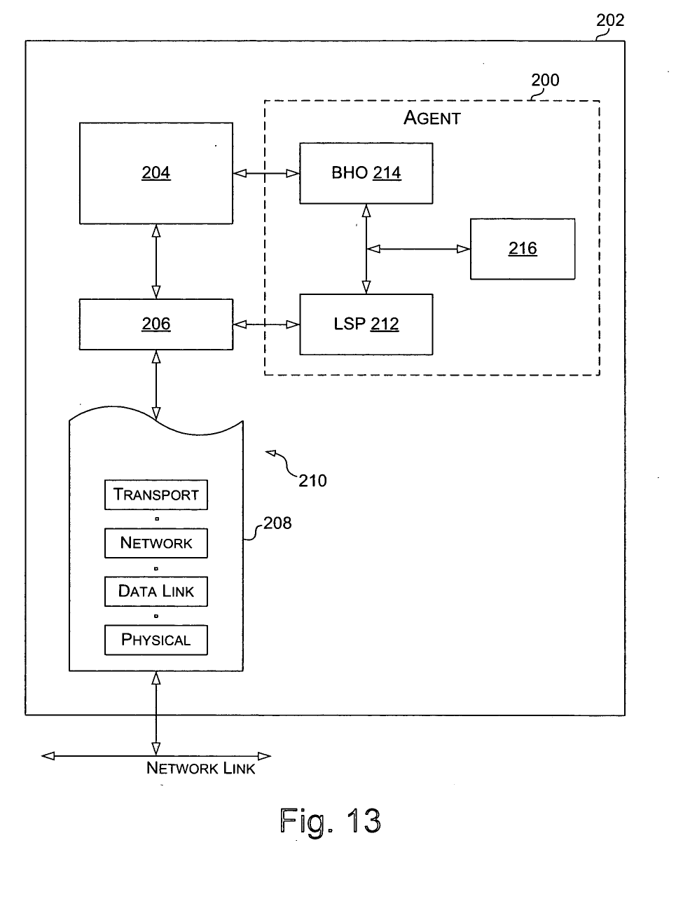

Referring to FIG. 13, the figure depicts a further embodiment of an agent module 200, along with its associated distributed computing device 202. In many respects, agent module 200 is similar to the previously described embodiments and may be provided with some or all of the features and sub-components described above. As in the previous discussion, the associated computer 202 includes an application program 204 and a socket object 206 that operatively couples the application program to the lower layers 208 of a network communications stack 210. As indicated, agent module 200 includes not only the LSP component (i.e., component 212), but also includes an additional application-level component 214. As will be discussed, the application-level component may be adapted to aid in determining transaction response time.

In the depicted example, application 204 is implemented as a browser program, and the additional component 214 may therefore be referred to as “Browser Helper Object,” or BHO. BHO 214 may be implemented as a .dll file using the Microsoft COM model, though many other alternate implementations are possible. BHO 214 operates at the application level (e.g., the application layer of the OSI or TCP/IP models), and therefore is able to interact with the application to identify transactions and obtain other information that is not readily accessible at lower protocol layers. BHO 214 typically determines response times by identifying the beginning and end times of particular transactions.

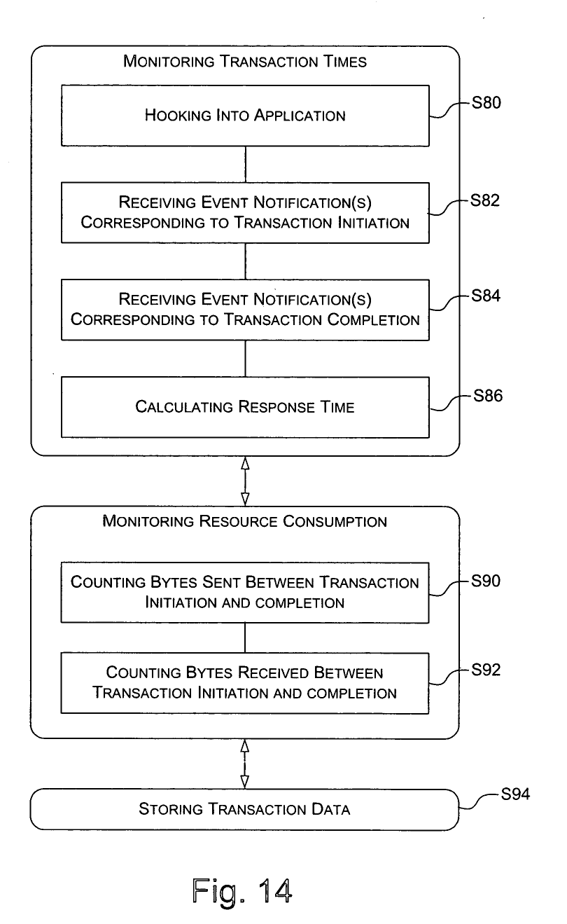

In one exemplary implementation on the Microsoft Windows platform, BHO 214 is registered in the Windows Registry as an Internet Explorer (IE) browser object. This registration causes IE to send event notifications to BHO 214 for specific events that occur within the browser application program. Each time a new IE process is created, IE calls the “SetSite( )” call for any registered Browser Helper Objects. When SetSite( ) is called in BHO 214, the BHO notifies IE that it wants notification for all web browser events. These events may include a variety of different types of events. Typically, events corresponding to the initiation and completion of transactions will be of primary interest. For example, BHO 214 may be configured to be responsive to browser event notifications such as: (1) DownloadBegin( ); (2) DocumentComplete( ); (3) DownloadComplete( ); and (4) NavigateComplete( ). Establishing the interaction between BHO 214 and the application program may be referred to as hooking into the application, as shown at S80 in the exemplary monitoring method depicted in FIG. 14.

Continuing with this example, LSP 212 may be configured to create a hidden window (e.g., hidden to the end user) when it is loaded for the first time. BHO 214 may be configured to find this window using a windows API call (e.g., “FindWindow( )”). Once BHO 214 has a handle to the window, BHO 214 uses another API call, such as “PostMessage( ),” to signal the start and end of a transaction as well as passing additional data to LSP 212 in the LPARAM argument of the “PostMessage( )” API call. Step S82 in FIG. 14 shows receiving of an event notification corresponding to initiation of the transaction. As discussed above, once this event notification is received, BHO 214 typically communicates to LSP 212 that the transaction has begun.

When a new page is requested in the “BeforeNavigate2( )” call, BHO 214 allocates global memory and sets the contents of that global memory to a structure containing the Process ID, Current System Time, Current Web Browser URL and a unique identifier for the window in case IE has multiple windows open for a single process. Once global memory has been allocated and set, BHO 214 calls “PostMessage( )” to the window that LSP 212 creates at startup, passing the global memory as the LPARAM of the call.

Once LSP 212 has received the start message from BHO 214, it begins summing all bandwidth sent and received for the process with the Process ID sent from BHO 214 and destroys the global memory from the message that was posted to the LSP hidden window. The bandwidth measurement is indicated in FIG. 14 at steps S90 and S92, and may be performed using the previously discussed components and features of the agent module. When the page has been completely received in the browser program and the page is loaded on screen, the browser notifies BHO 214 by calling “DocumentComplete( ).” When document complete is called, BHO 214 again allocates global memory setting the contents of the memory to a structure that contains the current time, the Process ID, the page title, the page URL and the transaction ID and sends that information to the LSP by using the “PostMessage( )” Windows API call. Steps S84 and S86 depict receiving the end-of-transaction notification and calculation of response time.

When LSP 212 receives the page complete message, LSP 212 creates a transaction record containing the total bandwidth sent and received by the process that matches the Process ID sent in the window message sent by BHO 214, and destroys the Global Memory allocated by the BHO. LSP 212 adds information to the transaction record such as the IP address of the source and destination machines, the DNS names of the source and destination machines, and the current logged on user. LSP 212 then passes that transaction record to the DRTrans.exe component (e.g., component 216) that runs on the local machine. This process or application 216 is responsible for maintaining a local store of the records as well as passing the records upstream to other components in the management system (e.g., a control point). Storing of the transaction data is shown in the depiction of the exemplary method implementation at S94.

Those skilled in the art will appreciate that any number of methods, protocols, etc. may be used to provide for interaction and communication between LSP 212 and BHO 214. The above discussion is intended as an example only. Alternate methods may be employed in addition to or instead of the above examples, including direct API calls, memory mapped files, named pipes and the like.

From the above, it should be understood that the systems and methods of the present disclosure enable correlation of transactions times with bandwidth consumed during the transaction. In particular, BHO 214 may be used to identify the start time of a transaction initiated by the application program, or by a user of the application. BHO 214 then informs LSP 212 of the pages and processes associated with the transaction. This is in contrast to prior response time measurement schemes, which typically are unable to associate a user transaction with the various processes and tasks that must be performed to conduct the transaction.

For example, a user transaction may involve obtaining data from multiple target addresses on the network. This commonly occurs with web pages, in which data for various portions of the page to be presented is provided from different locations. One web server may provide text, for example, while other servers provide advertisements, images, audio, etc. Where multiple targets are involved, the layered network software on the client device will have a separate network “conversation” for each target. In prior systems, the response time measurements typically are performed only on the individual network conversations, and there typically is no way to group or correlate all the conversations with the high-level transaction to which they correspond. Accordingly, there is no accurate measurement of the actual response time experienced by the user.

BHO 214 enables correlation of individual processes, conversations, tasks, etc. with the transaction to which they correspond, in order to obtain accurate measurement of response times experienced by the user. Data flows measured by LSP 212 are correlated with the monitored transaction to determine bandwidth consumption. Once the BHO identifies completion of the transaction (e.g., through event notifications as described in the example above), that information is passed to LSP 212. Then the agent software is able to calculate response time and bandwidth consumption for the monitored transaction.

A nearly limitless array of management features may be predicated on the combination of the response time and bandwidth consumption metrics. For example, bandwidth may be allocated so that client transactions targeting a particular resource meet minimum response-time thresholds. Transaction response times may be monitored and studied for diagnostic purposes. For example, widely disparate response times for similar transactions can be indicative of a problem within the network. Response time measurements may be correlated with user feedback to empirically determine what response times and bandwidth allocations are necessary to maintain a desired level of user satisfaction. Various systems within the network may be configured to ensure that specific users, applications, etc. receive minimum response time thresholds.

Indeed, response time and bandwidth management may be implemented in connection with virtually any practicable parameter, including application identity, user identity, device identity, source address, destination address, source port, destination port, protocol, URL, time of day, network load, network population, etc. This provides for a very powerful and flexible mechanism through which the described system can be used to monitor and control virtually any type of distributed network. The addition of transaction-level monitoring and control provides even more power and flexibility.

Those skilled in the art will further appreciate that the above systems and methods may be implemented in various configurations and architectures, including architectures having multiple tiers of management components. In many of the examples discussed above, the systems and methods are implemented architecturally in two tiers. The first tier may include one or more control modules, such as control points 72. Because the control points control and coordinate operation of agent modules 70, the control points may be referred to as “upstream” or “overlying” components, relative to the agent modules that they control. By contrast, the agents, which form the second tier of the system, may be referred to as “downstream” or “underlying” components, relative to the control points they are controlled by.

Further tiers may be implemented in connection with distribution and enforcement of system policies. For example, a management system according to the present description may be configured to enable an administrator to define enterprise wide policies on a central server such as an Enterprise Policy Server (EPS). in such an environment, the control point modules described herein may be implemented in connection with a Controlled Location Policy Server (CLPS). A given CLPS would retrieve policies pertinent to its location from a controlling EPS. The CLPS would then distribute policies to the relevant agent modules within its domain. Such a hierarchical tiered arrangement may be easily adapted and scaled to manage widely varying enterprise configurations. The distributed policies may, among other things, be used to facilitate the bandwidth management techniques described herein.

Hierarchical and/or tiered configurations can also be extended to individual agent modules, particularly for purposes of monitoring, controlling and otherwise managing bandwidth consumption by distributed devices. For example, each agent module may be configured to hierarchically subdivide bandwidth allocations among active applications and socket connections. The bandwidth allocation for a given distributed device may be received by the agent module and dynamically divided among all the applications that are active on the device, according to effective application priorities, past allocation consumptions, and/or other criteria. For each application on the device, the bandwidth allocation for that specific application may be further sub-allocated to individual socket connections associated with the application, depending on past consumption, effective priority, etc. Tiered implementations and other examples of distributed management systems and methods are disclosed in U.S. patent application Ser. No. 09/532,101, filed Mar. 21, 2000 and U.S. patent application Ser. No. 10/369,259, filed Feb. 18, 2003, the disclosures of which are incorporated herein by this reference, in their entireties and for all purposes.

While the present embodiments and method implementations have been particularly shown and described, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

What is claimed is:

1. A distributed computer network, comprising:
a plurality of distributed computing devices interconnected via a network link, where each of the computing devices is configured to run an application program and network communications software, and where the network communications software operatively couples the application program and network link;
a plurality of agent modules, each agent module being associated with one of the plurality of distributed computing devices such that the agent modules and computing devices are in a one-to-one relationship, each agent module being loaded into and operable from a memory location of its associated computing device, each agent module including:
a response time sub-module configured to monitor the application program of its associated computing device to determine response times for transactions involving data flows over the network link; and
a resource consumption sub-module configured to monitor data flows within a network communications data path defined in part through the network communications software, where such monitoring of data flows is performed to determine how much bandwidth on the network link is being consumed by the computing device with which the agent module is associated.

2. The network of claim 1, where the response time sub-module is configured to receive event notifications from a browser application program so as to determine response times for transactions initiated by the browser application program.

3. The network of claim 2, where the network is configured to correlate the response time for each transaction with bandwidth consumption data obtained by the resource consumption sub-module for such transaction.

4. Software for monitoring a computing device coupled within a distributed network, comprising:
a transaction monitor configured to determine response times for network transactions initiated by a user of the computing device, where such transaction monitor is configured to determine response times for transactions involving both single and multiple targets;
a resource consumption monitor configured to monitor data flows associated with transactions monitored by the transaction monitor, where the software is configured to correlate monitoring by the transaction monitor and resource consumption monitor so as to determine how much network bandwidth is consumed for each network transaction.

5. The software of claim 4, where the resource consumption monitor is configured to interact with a socket object adapted to operatively couple an application program running on the computing device with a network link.

6. The software of claim 4, where the computing device includes a layered protocol stack for effecting network communication, including a transport protocol layer, and where the resource consumption monitor is configured to monitor network data flows of the computing device at a transmission point between an application program running on the computing device and the transport protocol layer.

7. The software of claim 6, where the resource consumption monitor is configured to hook into a socket object interposed between the application program and the transport protocol layer.

8. The software of claim 4, where the transaction monitor is configured to receive event notifications from a browser application program so as to determine response times for transactions initiated by the browser application program.

9. The software of claim 8, where the event notifications include commencement of downloads required for a transaction.

10. The software of claim 8, where the event notifications include completion of downloads required for a transaction.

11. The software of claim 8, where the event notifications include completion of document loads required for a transaction.

12. The software of claim 8, where the event notifications include completion of browser navigation tasks required for a transaction.

13. The software of claim 4, where the software is configured to register the transaction monitor with an operating system of the computing device, such registration causing the transaction monitor to be classed as an object that is to receive event notifications from an application program running on the computing device, and where such event notifications correspond to initiation and completion of network transactions.

14. The software of claim 4, where the resource consumption monitor interacts with the transaction monitor to create a record for each network transaction, such record including quantification of bytes sent out to the distributed network and bytes received in from the distributed network by the computing device during the network transaction.

15. The software of claim 14, where each record further includes identifying data for each remote device involved in data flows of the network transaction.

16. The software of claim 14, where each record further contains data identifying a user of the computing device during the network transaction.

17. The software of claim 14, where the software is configured to periodically transmit records over the distributed network for processing at a centralized network management software program.

18. A method of monitoring a distributed computed device operatively coupled with other distributed computing devices via a network link, comprising:
determining a start time of a network transaction initiated at the distributed computing device;
determining a stop time of the network transaction, where the stop time corresponds to completion of the network transaction; and
monitoring data flows on the network link associated with the network transaction to determine an amount of bandwidth consumed in connection with performance of the network transaction.

19. The method of claim 18, where monitoring data flows includes determining a number of bytes sent by the distributed computing device during performance of the network transaction.

20. The method of claim 18, where monitoring data flows includes determining a number of bytes received by the distributed computing device during performance of the network transaction.

21. The method of claim 18, where monitoring data flows includes determining a number of bytes sent and received by the distributed computing device during performance of the network transaction.

22. The method of claim 18, where the distributed computing device communicates over the network link using a layered network communications stack, and where monitoring data flows includes monitoring the distributed computing device at a data transmission point between an application program running on the distributed computing device and a transport protocol layer of the layered network communications stack.

23. The method of claim 18, where the network transaction is initiated by an application program running on the distributed computing device, and where determining a start time and a stop time of the network transaction is performed using a software module configured to hook into the application program and receive event notifications from the application program corresponding to initiation and completion of transactions.
